(19) United States
(12) Patent Application Publication
(10) Pub. No.: US 2026/0168476 A1
(43) Pub. Date: Jun. 18, 2026

(54) VERTICAL AXIS WIND TURBINES AND METHODS OF MANUFACTURING THE SAME

(71) Applicant: Regents of the University of Minnesota, Minneapolis, MN (US)

(72) Inventors: Richard James, North Oaks, MN (US); Huan Liu, Minneapolis, MN (US)

(73) Assignee: Regents of the University of Minnesota, Minneapolis, MN (US)

(21) Appl. No.: 19/129,356

(22) PCT Filed: Jan. 12, 2024
(86) PCT No.: PCT/US2024/011355

§ 371 Date: May 13, 2025

Related U.S. Application Data
(60) Provisional application No. 63/439,014, filed on Jan. 13, 2023.

(51) Int. Cl. F03D 3/06; F03D 1/06; F03D 3/02; F03D 9/11; F03D 9/25

(52) U.S. Cl. CPC F03D 3/061; F03D 1/0675; F03D 3/02; F03D 3/062; F03D 3/067; F03D 3/068; F03D 9/11; F03D 9/25

(57) ABSTRACT

Vertical axis wind turbines (VAWT) and methods of installing. In some embodiments, the VAWT includes a stage and a deflector. The stage includes two turbine sub-units, each with a rotor. The rotors are arranged to rotate (in response to incident wind) in opposite directions, with the rotor blades intermeshing during rotation. The deflector diverts the incident wind from interfacing with a parasitic side of the blades as they rotate. In some embodiments, the rotor blades are origami-based, each being created at an installation site from a flat sheet imparted with origami-type features.

### BACKGROUND

This invention was made with government support under N00014-19-1-2623 awarded by the U.S. Department of Defense/Vannevar Bush Faculty Fellowship, under FA9550-23-1-0093 awarded by the U.S. Department of Defense/AFOSR, under N00014-18-1-2766 awarded by the U.S. Department of Defense/ONR, under FA9550-18-1-0095 awarded by the U.S. Department of Defense/MURI, and under FA9550-16-1-0566 awarded by the U.S. Department of Defense/MURI. The government has certain rights in the invention.

The present disclosure relates to wind turbines. More particularly, it relates to vertical axis wind turbines and methods of manufacturing the same.

Wind power entails the conversion of wind into useable energy (e.g., electrical power or electricity) via a wind turbine. Thus, the wind turbine converts kinetic energy from the wind into mechanical energy that in turn is converted into electricity. A wind turbine generally includes a rotor consisting of a hub supporting two or more blades; the rotor is supported by, or connected to, a main shaft that in turn is linked or attached to an electric generator. Electrical power is generated as the blades cause the rotor to rotate by incident wind.

The two primary types of wind turbine formats are horizontal axis wind turbine (HAWT) and vertical axis wind turbine (VAWT). With an HAWT, the rotor is mounted horizontally (meaning the rotational axis of the wind turbine is horizontal), whereas the rotor of a VAWT is mounted vertically. With vertical axis wind turbines, the rotational axis of the turbine stands vertical or perpendicular to ground. As compared to the HAWT, the VAWT can be ideal for installations where wind conditions are not consistent as the VAWTs receive wind from all directions, and are well-suited for use in more populated areas where large HAWTs would not be accepted and/or cannot be placed high enough to benefit from steady wind. VAWTs generally offer lower installation/maintenance costs compared to HAWTs.

VAWTs generally incorporate a Savonius or Darrieus design. Savonius VAWTs rely on drag to turn the blade, while Darrieus blades are designed to act as airfoils that generate lift to turn the rotor (similar to the wings of airplanes or traditional sales on sailboats). A main overall deficiency of VAWTs for both Savonius and Darrieus designs is that a positive torque is generated on only one side of the rotor (the “active side”); the other side is parasitic.

### BRIEF DESCRIPTION OF THE DRAWINGS

FIG. 1A is a perspective view of portions of a vertical axis wind turbine in accordance with principles of the present disclosure;

FIG. 1B is a different perspective view of the vertical axis wind turbine of FIG. 1A;

FIG. 2 is a simplified top view of the vertical axis wind turbine of FIG. 1A;

FIG. 3 is a simplified top view of another vertical axis wind turbine in accordance with principles of the present disclosure;

FIGS. 4A-4C is perspective views of linkage assemblies useful with the vertical axis wind turbines of the present disclosure;

FIGS. 5A and 5B illustrate operation of the vertical axis wind turbine of FIG. 1A in the presence of incident wind;

FIG. 6 is a perspective view of portions of another vertical axis wind turbine in accordance with principles of the present disclosure;

FIG. 7 is a perspective view of portions of another vertical axis wind turbine in accordance with principles of the present disclosure; and

FIG. 8 is a perspective view of portions of another vertical axis wind turbine in accordance with principles of the present disclosure.

### DETAILED DESCRIPTION

The present disclosure relates to vertical axis wind turbines and methods for making or constructing the same. The vertical axis wind turbines of the present disclosure are generally of the Savonius type, and can include origami-formed blades. In some embodiments, the vertical axis wind turbines of the present disclosure include two or more rotors along with features that promote increased wind loading at the rotor blades.

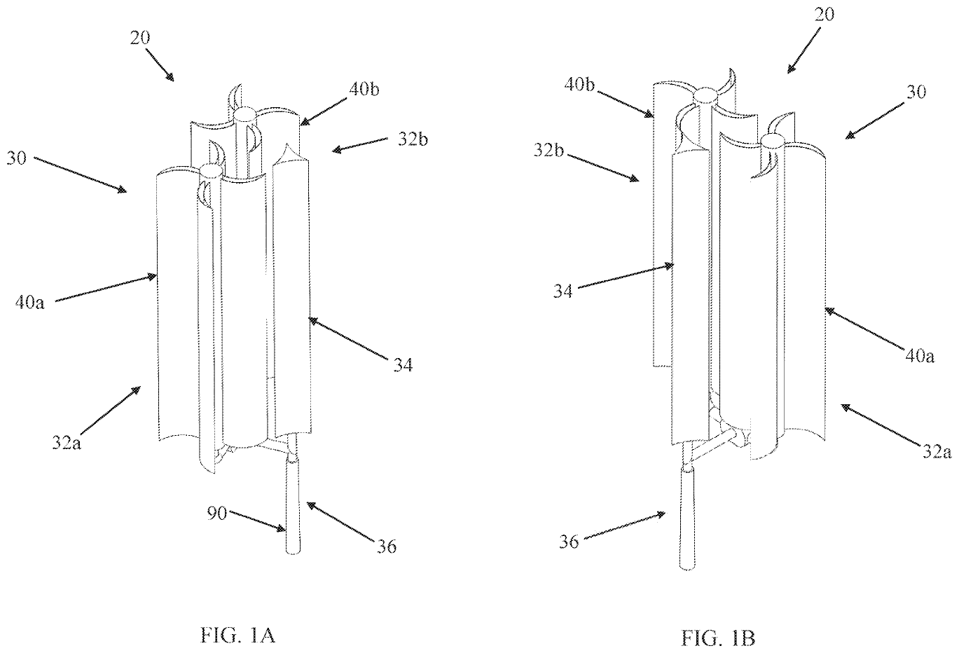

Portions of one embodiment of a vertical axis wind turbine 20 of the present disclosure is shown in FIG. 1A, and 1B. The vertical axis wind turbine 20 includes a stage 30 having first and second turbine sub-units 32a, 32b (referenced generally), a deflector 34, and a support assembly 36. Details on the various components, as well descriptions of additional components hidden or not shown in the views, are provided below. In general terms, each of the sub-units 32a, 32b includes a rotor 40a, 40b arranged to rotate about a corresponding axis of rotation. Each rotor 40a, 40b is connected to a corresponding rod (hidden) that rotates with rotation of the rotor 40a, 40b. Rod rotation is transmitted (e.g., via a gearbox and primary drive shaft (not shown)) to an electric generator (hidden). A configuration and arrangement of the rotors 40a, 40b relative to one another, as well as an arrangement of the deflector 34, dictates transfer of momentum of the wind to the rotors 40a, 40b. The support assembly 36 maintains the stage 30, the deflector 34, and other components relative to ground/installation site. In some optional embodiments, the support assembly 36 can be configured to permit collective rotation of the stage 30 and the deflector 34 about a common axis to face the wind in all directions.

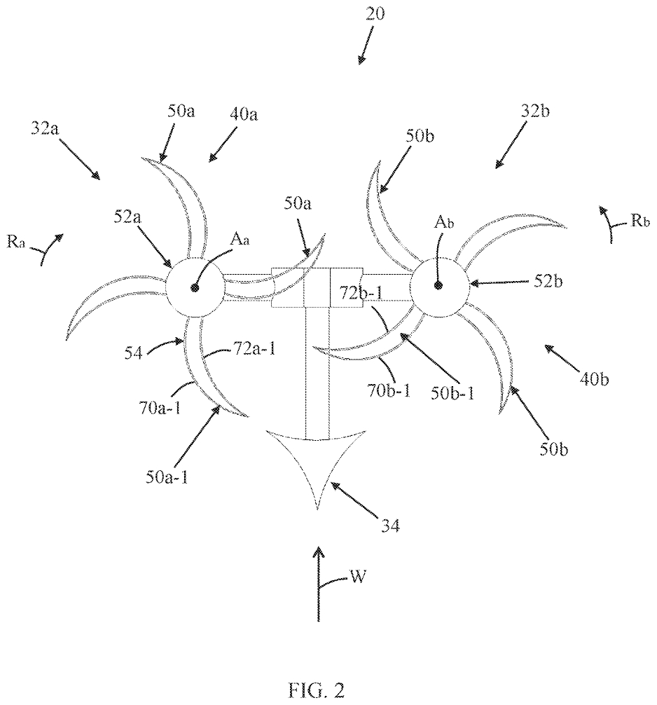

With additional reference to FIG. 2, that otherwise provides a simplified top view of the vertical axis wind turbine 20 (with the support assembly 36 removed for ease of understanding), the rotor 40a of the first turbine sub-unit 32a includes a plurality of blades 50a extending from and supported by a hub 52a. The rotor 40a is arranged to rotate about an axis Aa. The blades 50a can be substantially identical, and in some non-limiting embodiments are each formed by one or more sheets of material connected to the hub 52a and maintained in a predetermined spatial shape pursuant to an origami-type design imparted into the sheet(s). For example, the plurality of blades 50a of the first sub-unit 32a includes a first blade 50a-1. In some embodiments, the first blade 50a-1 is generated by a single sheet of material 54 imparted with one or more fold lines, creases, or other origami-like features. Prior to connection or assembly to the hub 52a, the single sheet of material 54 can be maintained in a relatively flat state (e.g., during delivery to an installation site); when connected or assembled to the hub 52a, the single sheet of material 54 readily or naturally folds to the blade shape of FIGS. 1A-2 due to the origami-type features imparted or designed into the sheet 54. The remaining blades 50a can have a substantially similar construction, with each of the blades 50a being substantially identical to one another.

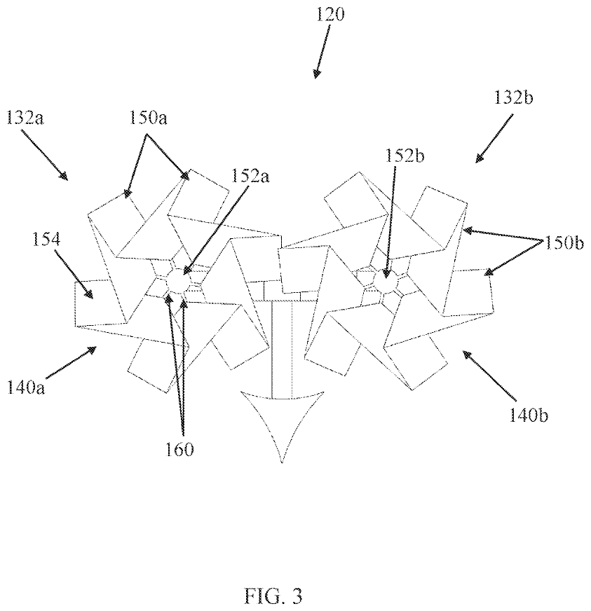

While each of the blades 50a have been described as optionally being formed by a respective, individual sheet of material, in other non-limiting embodiments, one or more or all of the blades 50a can each be formed by two or more sheets of material each imparted with origami-type feature(s) and configured to assume the predetermined blade shape upon connection of assembly to the hub 52a and each other. In other embodiments, two or more or all of the blades 50a can be collectively formed or defined by a single sheet of material imparted with origami-type features. For example, FIG. 3 illustrates, in simplified form, portions of another vertical axis wind turbine 120 of the present disclosure that includes first and second turbine sub-units 132a, 132b that each includes a rotor 140a, 140 b, respectively, having a plurality of blades 150a, 150b. With the embodiment of FIG. 3, the plurality of blades 150a of the first sub-unit 132a are generated or formed by a single sheet of material 154. The sheet of material 154 is imparted with origami-type features that cause the sheet of material 154 to self-assume the pre-determined or imparted design shape of FIG. 3 upon mounting or connection to the hub 152a (e.g., via support arms 160), with this pre-determined, imparted design shape defining each of the blades 150a. The plurality of blades 150b of the second sub-unit 132b can similarly be generated or formed by a single sheet of material folded to an origami-imparted design and assembled to the hub 152b in some examples. Returning to FIGS. 1A-2, the second turbine sub-unit 32b can be identical or substantially identical to the first turbine sub-unit 32a, with the rotor 40b including a plurality of blades 50b connected to, and extending outwardly relative to, a hub 52b. The rotor 40b is rotatable about an axis A_{b}. The blades 50b of the rotor 40b can have any of the forms or constructions described above, and are identical or substantially identical, in terms of at least number, size, and shape, to the blades 50a of the first turbine sub-unit 32a. Thus, in some non-limiting embodiments, one or more or all of the blades 50b are each formed by one or more sheets of material connected to the hub 52b and maintained in a predetermined spatial shape pursuant to an origami-type design imparted into the sheet(s).

The blades of the present disclosure can optionally be formed or manufactured using techniques other than the origami-based designs described above. For example, in some embodiments, one or more of the blades of the present disclosure (e.g., the blades 50a, 50b) can be manufactured by extrusion, molding, or the like (e.g., capable of generating an axially uniform blade design) as a solid or hollow body.

Upon final assembly, the first and second turbine sub-units 32a, 32b are horizontally aligned and maintained at a lateral spacing (i.e., distance between the axes of rotation Aₐ, A_{b}) in which with the blades 50a, 50b mesh with one other. Stated otherwise, and with specific reference to FIG. 2, upon final assembly, a rotational arrangement of the rotor 40a of the first turbine sub-unit 32a differs slightly from that of the rotor 40b of the second turbine sub-unit 32b (in particular, a collective rotational arrangement of the blades 50a of the first turbine sub-unit 32a about the axis of rotation Aₐ differs from or is rotationally off-set relative to, a collective rotational arrangement of the blades 50b of the second turbine sub-unit 32b about the axis of rotation A_{b}) such that as the rotors 40a, 40b rotate, the blades 50a, 50b intermesh with one another and do not collide.

As described in greater detail below, a three-dimensional shape of each of the blades 50a, 50b is selected or designed to interface with incident wind in various manners as the corresponding rotor 40a, 40b rotates about the respective axis of rotation Aₐ, A_{b}. With this in mind, while the blades 50a, 50b may have an identical or substantially identical shape, in some embodiments the rotors 40a, 40b are configured to naturally rotate in opposite directions in response to incident wind, for example by the blades 50a of the first turbine sub-unit 32a being arranged as a mirror image of the blades 50b of the second turbine sub-unit 32b. By way of further explanation, a shape of the first blade 50a-1 of the first turbine sub-unit 32a can be described as defining a first side 70a-1 opposite a second side 72a-1. The first side 70a-1 has a generally convex shape whereas the second side 72a-1 is generally concave (relative to the plane of FIG. 2). The convex/concave shapes of the sides 70a-1, 72a-1 interface differently with incident wind (generally represented by the line W); with the spatial arrangement of FIG. 2, the incident wind W acts upon the first blade 50a-1 (as well as the remaining, similarly arranged blades 50a) to cause the rotor 40a to rotate about the axis Aₐ in a first rotational direction Rₐ (clockwise relative to the orientation of FIG. 2). A first blade 50b-1 of the second sub-unit 32b similarly has a first side 70b-1 opposite a second side 72 b-1; the first side 70b-1 is generally convex whereas the second side 72b-1 is generally concave, identical to the sides 70a-1, 72a-1, respectively, as described above. However, the first blade 50b-1 of the second sub-unit 32b is opposite, or a mirror image of, the first blade 50a-1 of the first sub-unit 32a. As a result, the incident wind W acts upon the first blade 50b-1 (as well as the remaining, similarly arranged blades 50 b) to cause the rotor 40b of the second turbine sub-unit 32b to rotate about the axis A_{b} in a second rotational direction R_{b} that is opposite the first rotational direction Rₐ of the rotor 40a of the first turbine sub-unit 32a (i.e., the incident wind W causes the rotor 40b of the second turbine sub-unit 32b rotate counterclockwise relative to the orientation of FIG. 2). In other words, the rotors 40a, 40b have a counter-rotating design. Other configurations are also envisioned that may or may not implicate the rotors 40a, 40b rotating in opposite directions.

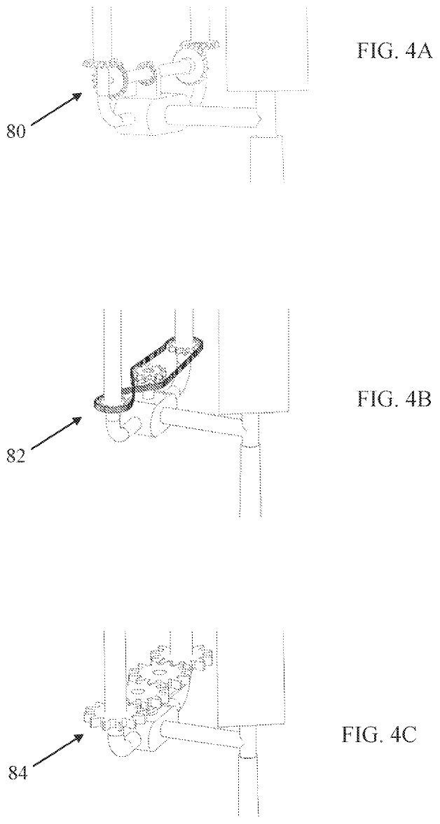

In some embodiments, the vertical axis wind turbines of the present disclosure can optionally include one or more components that link the rotors 40a, 40b in a manner that better ensures that the rotors 40a, 40b rotate or spin at the same angular velocity. For example, chains, belts, pulleys, etc., can be included that link the two rotors 40a, 40b at their respective bases. One non-limiting examples of a possible linking assembly 80 is shown in FIG. 4A. Other example linking assemblies 82, 84 are shown in FIGS. 4B and 4C, respectively. A variety of other linking assembly designs or components can alternatively be employed.

Returning to FIGS. 1A-2, the deflector 34 is configured and arranged to direct or deflect the incident wind W in a desired manner relative to the rotors 40a, 40b. In some embodiments, the deflector 34 can have the generally triangular shape reflected by FIG. 2, and extends an entire length (or height) of the blades 50a, 50b. A shape of the deflector 34 is matched to a shape of the blades 50a, 50b, and is designed in accordance with aerodynamic principles. For example, the deflector 34 is configured to transfer momentum of the incident wind W to the blades 50a, 50b in a manner that promotes maximum power over the expected range of wind conditions. In some embodiments, the deflector 34 is centrally located relative to the rotors 40a, 40b, positioned in close proximity to, but slightly spaced from, the blades 50a, 50b so as to not impede free rotation. In some embodiments, the deflector 34 can have an axially uniform shape and is formed by extrusion, molding, machining, etc.

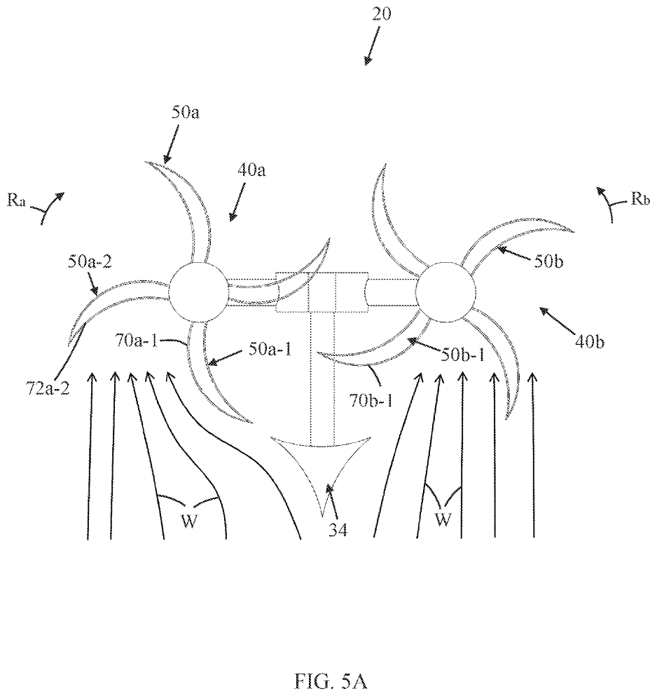

Operation of the vertical axis wind turbine 20 in the presence of incident wind W can be described with initial reference to FIG. 5A, that otherwise provides a simplified representation of the rotors 40a, 40b at a first point in time (T₁). Commensurate with the descriptions of above, the rotors 40a, 40b (and in particular the blades 50a, 50b thereof) are arranged such that the incident wind W is causing the rotors 40a, 40b to rotate in opposite directions (i.e., relative to the orientation of FIG. 5A, the first rotor 40a is rotating in a clockwise direction Rₐ, whereas the second rotor 40b is rotating in a counterclockwise direction R_{b}). At time T₁, rotation of the first rotor 40a is such that the first blade 50a-1 of the first rotor 40a has just passed the deflector 34. At time T₁, and for a short time following time T₁, the first blade 50a-1 of the first rotor 40a acts as an airfoil (via the incident wind W interfacing with the first side 70a-1). Also, at time T₁, the second blade 50a-2 of the first rotor 40a acts similar to a spinnaker on a sailboat (via the incident wind W interfacing with the second side 72a-2), also providing a significant torque. The deflector 34 can be shaped to direct the incident wind W relative to the first rotor 40a as shown. The second rotor 40b is simultaneously rotating (in the direction R_{b}); at time T₁, the first blade 50b-1 of the second rotor 40b is shielded from the incident wind W by the deflector 34 so as to minimize the parasitic effect. In other words, absent the deflector 34, the incident wind W would directly interface with the first side 70b-1 of the first blade 50b-1 of the second rotor 40b in a manner imparting a moment force opposite the counterclockwise rotational direction R_{b} (i.e., at time T1, the first side 70b-1 can be considered a parasitic side of the first blade 50b-1). The deflector 34 diverts the wind W from the parasitic side of the first blade 50b-1.

FIG. 5B reflects an arrangement of the rotors 40a, 40b at a second, later point in time T₂ (i.e., in transitioning from the state of FIG. 5A at time T₁ to the state of FIG. 5B at time T₂, the first rotor 40a has rotated clockwise and the second rotor 40b has rotated counterclockwise). At time T₂, the first blade 50b-1 of the second rotor 40b has just passed the deflector 34. Thus, at time T₂, and for a short time following time T₂, the first blade 50b-1 of the second rotor 40b acts as an airfoil (via the incident wind W interfacing with the first side 70b-1). Also, at time T₂, the second blade 50b-2 of the second rotor 40b acts similar to a spinnaker on a sailboat (via the incident wind W interfacing with the second side 72b-2), also providing a significant torque. The first blade 50a-1 of the first rotor 40a is transforming or transitioning (with continued clockwise rotation Rₐ of the first rotor 40a) from an airfoil-like interface with the incident wind W to a spinnaker-like interface, and provides continued significant torque. All other blades 50a, 50b are shielded from the incident wind W by either the deflector 34 or other blades 50a, 50b, minimizing the parasitic effect.

Returning to FIGS. 1A-2, the support assembly 36 can assume various designs conducive to supporting the stage 30 and the deflector 34 relative to ground (or other installation site). For example, in some non-limiting embodiments, the support assembly 36 can include a central base pole 90 or similar structure defining an axis about which the stage 30 and the deflector 34 can collectively rotate. With these and related embodiments, and due to asymmetry of the sub-units 32a, 32b and the deflector 34 relative to one another, the stage 30 and the deflector 34 will naturally rotate (e.g., no motor or similar device is required) to face the wind.

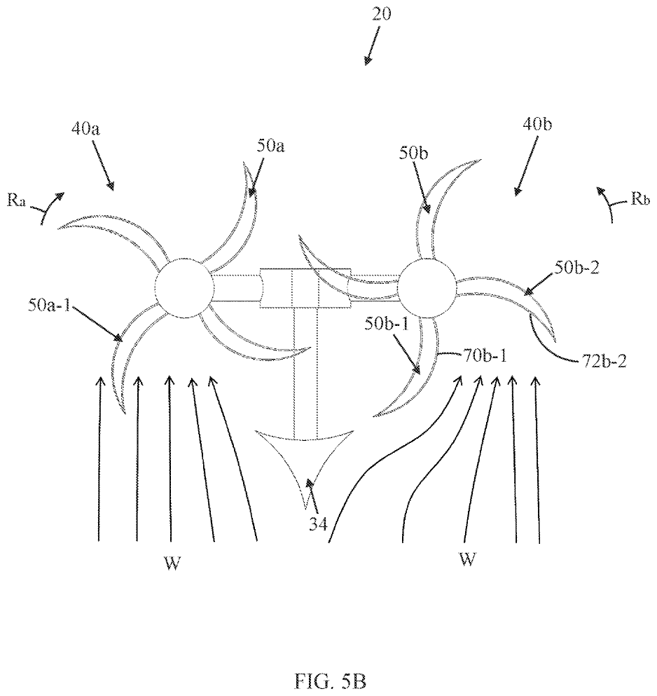

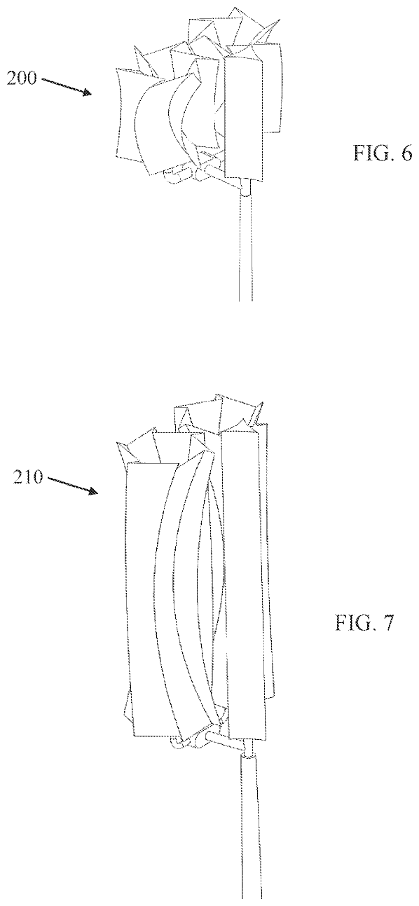

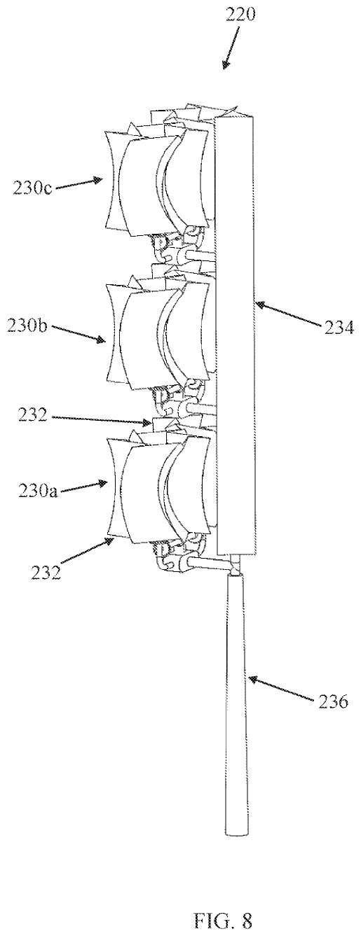

The rotors of the present disclosure can incorporate blade shapes differing from the specific shapes implicated by FIGS. 1A-2. FIGS. 6 and 7 illustrate portions of vertical axis wind turbines 200, 210, respectively, and reflect non-limiting examples of other blade shapes in accordance with principles of the present disclosure. While the vertical axis wind turbine 20 has been shown as including the single stage 30, other configurations are also acceptable. In other embodiments, two or more stages (each with two turbine sub-units) can be provided. For example, FIG. 8 illustrates portions of another vertical axis wind turbine 220 of the present disclosure. The turbine 220 includes three stages 230a-230c (each with two turbine sub-units 232 (labeled for the first stage 230a)), a deflector 234 and a support assembly 236. The stages 230 can be identical, and can have any of the forms described above. As shown, the stages 230a-230c are vertically aligned. While rotors of each stage 230a-230c are shown as being independent of, or uncoupled relative to, the rotors of the remaining stages 230a-230c, in other embodiments all rotors on one axis could be joined to a single rod at the center of that axis. With these and related embodiments, extraction of power could be simplified, for example done at the base of the lowest (first) stage 230a. Regardless, the deflector 234 extends vertically along an entire length (or height) collectively defined by the stages 230a-230c. With this configuration, the deflector 234 serves to direct and/or deflect wind relative to the blades of each of the stages 230a-230c as described above. In other embodiments, two (or more) deflectors 234 can be provided.

With any of the embodiments of the present disclosure which the blades (e.g., the blades 50a, 50b of FIGS. 1A-2) are designed by origami design methods, a Lagrangian mathematical approach for curved tile structures can be employed. As a point of reference, in origami design, the fold lines are created in a thin sheet of material to render the thin sheet foldable. The fold lines can be referred to as creases, and the material between creases can be referred to as tiles. With some of the origami-based blades of the present disclosure, the fold lines or creases are straight or curved, and the tiles undergo deformations that leave them curved. In some embodiments, the origami-generated blades are configured such that the tiles deform elastically while the rotor is turning. These tiles deform only due to the forces of the wind; a separate actuator is not required. Moreover, the blades can be configured such that that the tiles deform in a desired fashion so that torque is enhanced. The sheet(s) from which the blades are generated can be designed to be foldable from a flat state by isometric mappings—that is, bending but no stretching. The tiles generated within the resultant blade structure will undergo so-called “isometric deformations” in which the center plane bends but does not stretch.

The optional origami-based blade design methods of the present disclosure permit, in some embodiments, the design of blades that can be manufactured conveniently as flat sheets, and then folded to the final state at the vertical axis wind turbine installation site. In related embodiments, an entire rotor can be flat-foldable. Regardless, the origami-based methods of the present disclosure simplify the transport and assembly of the vertical axis wind turbine. Another advantage of the origami design methods of the present disclosure is that significant rigidity can be built into the vertical axis wind turbine by deploying the blades in a deformed configuration. In some embodiments, the need for a complex system of fasteners can be avoided. Moreover, modes of buckling or other failure mechanisms can be analyzed and avoided up-front to ensure a robust design for robust wind conditions.

The vertical axis wind turbines and methods of manufacture/assembling of the present disclosure provide a marked improvement over previous designs. For example, the tiles of the origami-designed blades can be deformable thin tiles with a relatively low material cost. By adjusting the thickness of these tiles, the vertical axis wind turbine can potentially be made of a variety of materials to achieve the same function, optimizing costs and/or lifetime. Compared to horizontal axis wind turbines and conventional vertical axis wind turbines, the vertical axis wind turbines of the present disclosure, and in particular the optional origami-based blades (in which each turbine blade is generated or formed from a flat sheet or tile), simplify the manufacturing process resulting in a relatively low cost of fabrication. Moreover, since the blades can be generated or formed (e.g., folded into a shape origami-based tiles) on site from a flat sheet, transportation and installation is simplified with potentially less carbon cost, especially as comparted to the challenging transportation and installation of horizontal axis wind turbines. Efficiency of the vertical axis wind turbines of the present disclosure (as measured by overall power produced per year) can be significantly improved by origami design, modern aerodynamic principles, and computational methods. In other embodiments, the turbine blades can be formed or manufactured by extrusion, molding, machining, etc. The design can be quite easily modified to suit different locations for deployment/installation. The vertical axis wind turbines of the present disclosure can be less intrusive in populated areas and/or create smaller shadowing in farming areas as compared to conventional horizontal axis wind turbines. The design of the vertical axis wind turbines of the present disclosure can be much simpler than conventional horizontal axis wind turbines, for example because wind-tracking mechanism (e.g., motor and gear box) are not required. Relatedly, maintenance is simplified (as compared to horizontal axis wind turbines) because the generator is near ground level and easily accessible. Wiring is simpler and less costly; powerlines or even grid integration may not be desired or needed. In addition, the vertical axis wind turbines of the present disclosure can operate effectively in slow wind conditions; by way of comparison, horizontal axis wind turbines require a starting motor and high cut-in wind speed.

Although the present disclosure has been described with reference to preferred embodiments, workers skilled in the art will recognize that changes can be made in form and detail without departing from the spirit and scope of the present disclosure.

1. A vertical axis wind turbine comprising:
at least one stage including first and second turbine sub-units, wherein each of the turbine sub-units includes a rotor having a plurality of blades connected to a hub;
a deflector; and
a support assembly maintaining the stage and the deflector such that:
each of the hubs are rotatable about a corresponding axis of rotation and the blades of the first turbine sub-unit intermesh with the blades of the second turbine sub-unit, and
the deflector transfers momentum of incident wind to the blades of the first and second turbine sub-units.

2. The vertical axis wind turbine of claim 1, wherein the stage is configured such that the rotor of the first turbine sub-unit and the rotor of the second turbine sub-unit rotate in opposite directions in response to incident wind.

3. The vertical axis wind turbine of claim 1, wherein the blades of the first turbine sub-unit are arranged as a mirror image of the blades of the second turbine sub-unit.

4. The vertical axis wind turbine of claim 1, wherein a first blade of the plurality blades of the first turbine sub-unit is formed by at least one sheet of material connected to the corresponding hub and incorporating origami features.

5. The vertical axis wind turbine of claim 4, wherein the origami features include a crease formed in the sheet of material to define opposing tiles at opposite sides of the crease, and further wherein the crease is curved.

6. The vertical axis wind turbine of claim 5, wherein the tiles are configured to deform elastically while the rotor is turning.

7. The vertical axis wind turbine of claim 5, wherein the tiles are configured to be rigid upon installation.

8. The vertical axis wind turbine of claim 4, wherein the first blade is generated by single sheet of material.

9. The vertical axis wind turbine of claim 1, wherein at least one of the blades of the first turbine sub-unit is formed by a process selected from the group consisting of extrusion, molding, and machining.

10. The vertical axis wind turbine of claim 1, further comprising a linking assembly that links the rotors.

11. The vertical axis wind turbine of claim 1, wherein the deflector is an elongated body having a triangular shape.

12. The vertical axis wind turbine of claim 11, wherein the deflector is centrally located relative to the rotors.

13. The vertical axis wind turbine of claim 1, wherein the support assembly maintains the stage and the deflector to be collectively rotatable about a common axis.

14. A method of assembling a vertical axis wind turbine, the method comprising:
assembling a stage including first and second turbine sub-units, each of the turbine sub-units including a rotor having a plurality of blades connected to a hub;
connecting the stage to a support assembly such that the blades of the first turbine sub-unit intermesh with the blades of the second turbine sub-unit with rotation of the rotors; and
mounting a deflector to the support assembly such that the deflector is arranged to transfer momentum of incident wind to the blades of the first and second turbine sub-units.

15. The method of claim 14, wherein the step of assembling a stage includes:
folding at least one flat sheet of material to form at least one blade of the first turbine sub-unit; and
connecting the at least one blade to the corresponding hub.

16. The method of claim 15, wherein the step of assembling further includes:
delivering the at least one flat sheet of material to an installation site in a flattened state.

17. The method of claim 16, wherein the at least one flat sheet of material, as delivered to the installation site, has at least one pre-formed crease.

18. The method of claim 17, wherein in the at least one flat sheet of material is configured to naturally fold at the at least one pre-formed crease upon connection to the corresponding hub.

19. The method of claim 14, wherein the step of mounting the deflector to the support assembly includes centrally locating the deflector relative to the rotors.

20. The method of claim 14, further comprising:
mounting the support assembly to ground such that:
the hubs extend vertically; and
the turbine sub-units and the deflector are collectively rotatable about a common axis.
